(19) United States
(12) Patent Application Publication
(10) Pub. No.: US 2006/0242573 A1
(43) Pub. Date: Oct. 26, 2006

(54) User-defined interface editing methods and systems

(75) Inventors: Chin Hwa Hu, Sijhih City (TW); Meng-Xi Zhuang, Taipei City (TW); Chao-Lung Lee, Banciao City (TW); Chia-Hoang Lee, Taipei City (TW); Yu-Chuan Yang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/113,478

(22) Filed: Apr. 25, 2005

(51) Int. Cl. G06F 17/00

(52) U.S. Cl. 715/530

(57) ABSTRACT

User-defined interface editing methods for mobile electronic devices. Display-related information of an interface is edited as modified information in an interface editor. The modified information is transmitted from the interface editor to the mobile electronic device. The interface is displayed on the mobile electronic device according to the modified information after parsing.

### BACKGROUND

The invention relates to interface display methods, and in particular to editing and display of user-defined interfaces for mobile electronic devices.

With technical progress in mobile electronic devices, such as mobile phones or personal digital assistants (PDAs), some personalized functions may be incorporated therein. Presently, such personalized functions are limited. For example, changeable outer housings, sounds, or background images may be provided in a mobile phone for selection.

Practically, user interfaces are used frequently in a mobile electronic device. Thus, a user-defined interface is desirable. Some products provide partial user-defined interfaces, where different background images for interface are provided for selection, while the provided layouts of the components on the interface are unchangeable. For example, a user interface can be displayed on a mobile phone as shown in FIG. 1. The interface 10 may comprise components, such as a timer 110, a menu icon 102, and so on. While the background image 106 may be replaced by another background image based on the user's selection, the layouts, such as the positions, colors, or shapes, of the components 102, 104, 108, or 110 cannot be changed.

### SUMMARY

In an exemplary embodiment of a user-defined interface editing method, display-related information of an interface is edited as modified information in an interface editor. The modified information is transmitted from the interface editor to a mobile electronic device. The interface is displayed on the mobile electronic device according to the modified information after parsing.

### DESCRIPTION OF THE DRAWINGS

The invention can be more fully understood by reading the subsequent detailed description and examples with references made to the accompanying drawings, wherein:

FIG. 1 is a diagram of an interface displayed on a mobile phone.

FIG. 2 is a flowchart of an embodiment of a user-defined interface editing method.

FIG. 3 is a diagram of an embodiment of a user-defined interface editing system.

FIG. 4 is a diagram of an embodiment of an interface editor.

FIG. 5 is a diagram of an embodiment of a displayed user-defined interface.

FIG. 6 is a diagram of an embodiment of a mobile electronic device.

### DESCRIPTION

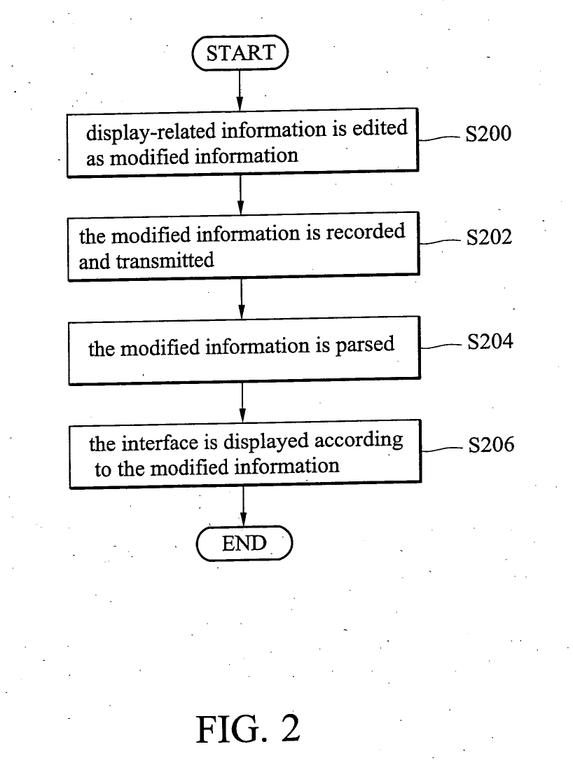

Editing methods for user-defined interfaces are provided. FIG. 2 is a flowchart of an embodiment of a user-defined interface editing method. Display-related information of an interface is edited as modified information in an interface editor (step S200). The interface can be displayed on a mobile electronic device and may comprise display components, such that the display-related information comprises descriptions of the display components, for example, positions, colors, or sizes thereof. The editing changes the descriptions of the display components. The display-related information of the interface can be sent from the mobile electronic device to the interface editor or installed previously therein.

Thereafter, the modified information is recorded and transmitted from the interface editor to the mobile electronic device, via wired or wireless transmission (step S202). The modified information can be recorded as an XML file. The modified information is parsed by a parser in the mobile electronic device before display on the interface (step S204). After parsing, the interface is displayed on the mobile electronic device according to the modified information (step S206).

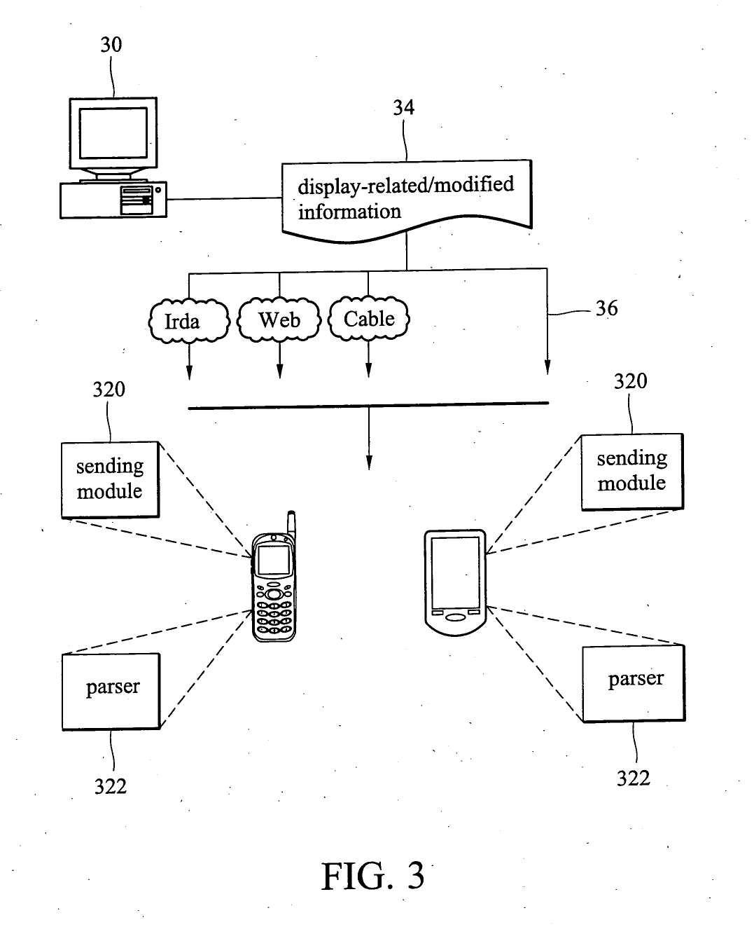

FIG. 3 is a diagram of an embodiment of a user-defined interface editing system. User-defined interface editing system, comprising an interface editor 30 and a mobile electronic device 32, are provided. The mobile electronic device 32 can be a mobile phone or a PDA. The interface editor 30 may be installed in a computer or provided in a website, and a user can use the interface 30 for editing the interface of the mobile electronic device 32 by changing the descriptions of the display components.

In some embodiments, the user firstly transmits the original interface of the electronic device 32, such as a mobile phone, to the computer with the interface editor 30 installed, or uploads the original interface of the electronic device 32 to the website with the interface editor 30 provided, where the user can use the interface editor via a browser. That is, the display-related information of the interface of the mobile electronic device 32 is transmitted to the interface editor 30.

In some embodiments, the electronic device 32 may have the interface editor 30 install therein, and the user can directly edit the interface on the electronic device 32 without the transmission.

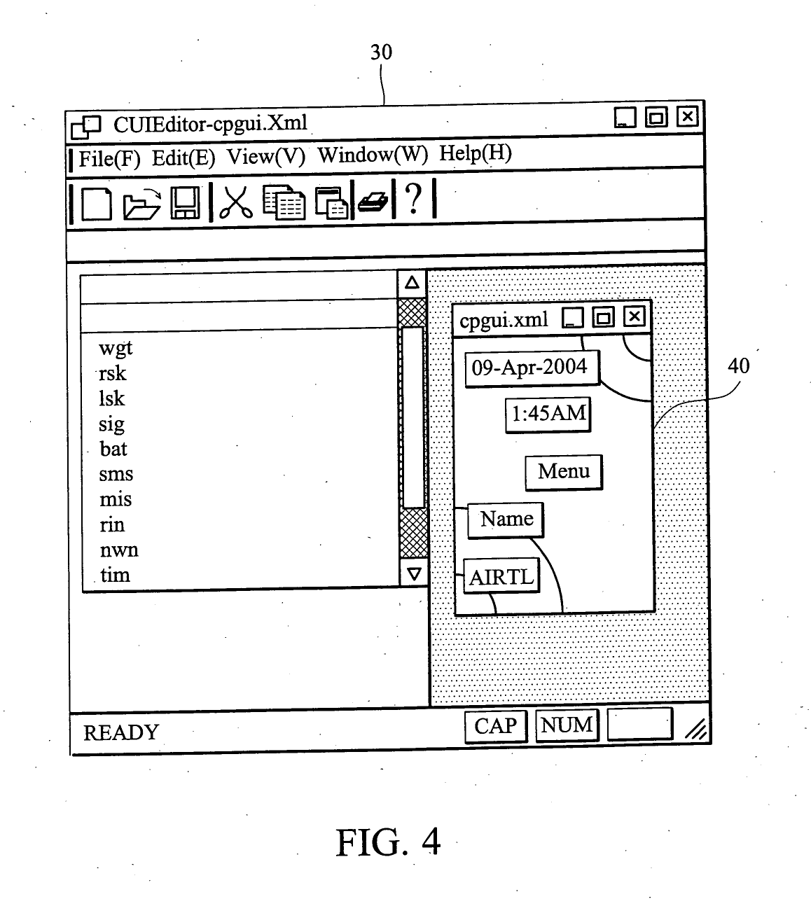

Then, the original interface of the electronic device 32 will be shown on the right portion of the working interface of the interface editor 30, as shown in FIG. 4, while the identification codes corresponding to the components displayed on the interface of the electronic device 32 are listed on the left portion of the working interface of the interface editor 30.

For example, in order to change the position of one component, such as the timer, on the interface of the electronic device 32, the user can choose the timer component on the right portion of the working interface of the interface editor 30 and change its position by moving and dragging the timer component to another position.

Also, the user can select the identification code corresponding to the timer component, and editing the position of the timer component by inputting a new position coordinate. In the similar way, the user can change the color (shape, size) of the timer component by inputting or selecting a new color (shape, size) parameter.

Furthermore, the user also can use the interface editor to change the string and function corresponding to a specific component on the interface of the electronic device 32, a mobile phone. For example, on the original interface of the electronic device 32, a specific component is shown with a string of “PHONEBOOK,” and when that component is selected, the mobile phone will enter into the “PHONEBOOK” function. Furthermore; that component is corresponding to the hard key of “upward arrow” on the keyboard of the mobile phone, and when the user presses the hard key of “upward arrow,” it means the function of “PHONEBOOK” is selected.

The user can use the interface editor to change the string of that component to be “NOTEBOOK,” and therefore, that component will be displayed with the string of “NOTEBOOK” and when that component is selected, the mobile phone will enter into the “NOTEBOOK” function. Similarly, when the when the hard key of “upward arrow” is pressed by the user, it means that the function of “NOTEBOOK” is selected.

The interface editor 30 saves the new coordinates or parameters as modified information 34, and transmits the modified information 34 to the mobile electronic device 32. The modified information 34 can be recorded as a file, such as an XML file, so as to be transmitted to the mobile phone from the computer or downloaded to the mobile phone from the website. Transmission 36 can be wired or wireless.

The mobile electronic device 32 receives the modified information 34 and displays the interface according to the modified information 34. The mobile electronic device 32 further comprises a sending module 320 for sending the display-related information of the interface for editing from the mobile electronic device 32 to the interface editor 30.

Furthermore, the modified information 34 is parsed by a parser 322 in the mobile electronic device before interface display.

Here, again, the interface can be displayed on the mobile electronic device 32 and may comprise display components, such that the display-related information comprises descriptions of the display components. By changing the descriptions of the display components, the display-related information is edited. The display-related information of the interface can be sent from the mobile electronic device 32 to the interface editor 30 or pre-installed therein. Also, the interface editor 30 comprises a parser for parsing the display-related information so as to display the interface of the mobile electronic device 32 on its working interface.

Since the modified information 34 for a specific interface design is recorded as an XML file, the electronic device 32 can have several XML files stored in its memory. Therefore, the user can have various interface designs for selection by directly accessing the corresponding XML file in the memory of the mobile phone.

Furthermore, the XML file is simply a data file, and is independent of the application. Therefore, by accessing the XML file, the interface of the mobile phone can be changed to be a new one having different “look and feel” without modifying or coding the related application for displaying interface.

Also, the user can share a customized interface designed by him/herself with his/her friends by transmitting the XML file corresponding to the specific interface to the friend. The transmission may occur between two mobile phones via the MSN function.

Besides, the original design for the interface of the mobile phone is stored as a default file, and the mobile phone can recover the original interface by accessing the default file.

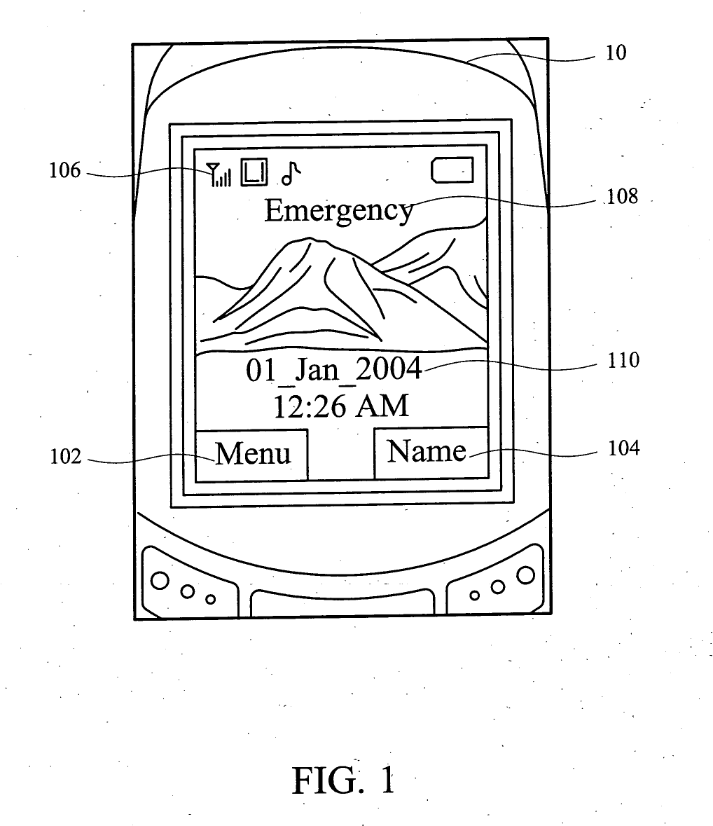

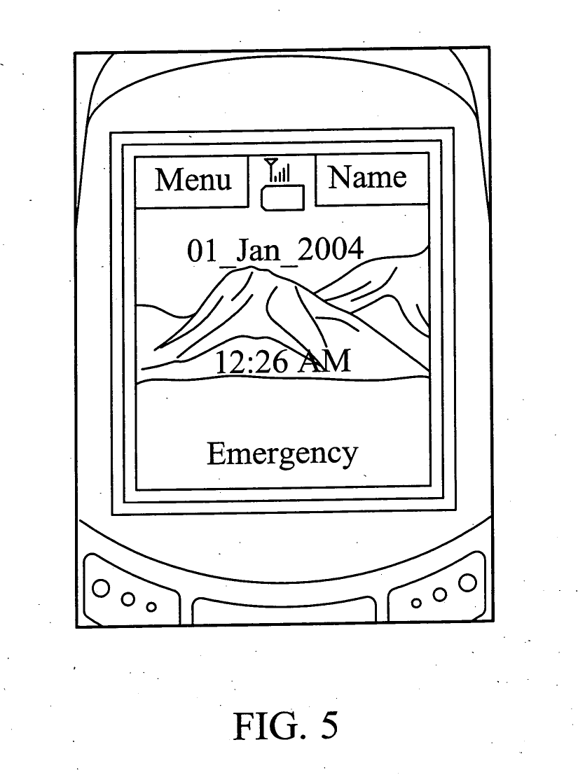

FIG. 5 is a diagram of an embodiment of a displayed user-defined interface. The user-defined interface is displayed on a mobile electronic device. Comparing FIG. 1 to FIG. 5, the positions of the displayed components are changed by applying the present invention. The user-defined interface as FIG. 5 is customized for meeting user's requirements.

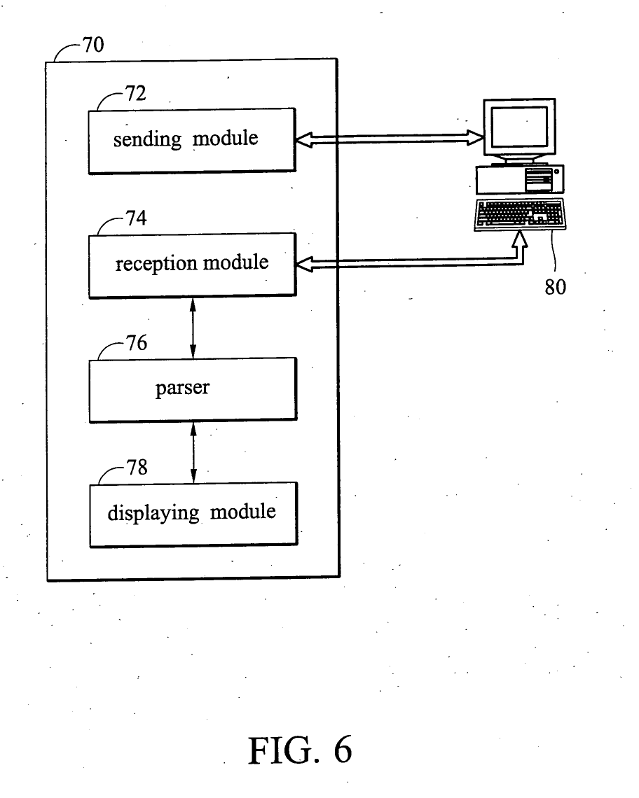

Additionally, a mobile electronic device is provided. FIG. 6 is a diagram of an embodiment of a mobile electronic device. The provided mobile electronic device 70 may comprise a sending module 72, a reception module 74, a parser 76, and a displaying module 78.

The sending module 72 sends the display-related information of the interface from the mobile electronic device 70 to the interface editor 80. The reception module 72 receives modified information from an interface editor 80. The modified information is produced by editing display-related information in the interface editor 80. The parser 76 is coupled to the reception module 64 and parses the modified information. The displaying module 78, coupled to the parser 76, displays the interface according to the modified information. Here, the interface and components thereof are edited, recorded, and transmitted as previously mentioned.

In some embodiment, the interface editor 30 may be installed in the mobile electronic device 32, such as a mobile phone. By this way, the user can edit and display the user interface without transmission.

Methods of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A user-defined interface editing method, comprising:
editing display-related information of an interface as modified information in an interface editor, wherein the interface is displayed on a mobile electronic device; and
displaying the interface on the mobile electronic device according to the modified information.

2. The user-defined interface editing method as claimed in claim 1, further transmitting the modified information from the interface editor to the mobile electronic device.

3. The user-defined interface editing method as claimed in claim 1, further sending the display-related information of the interface from the mobile electronic device to the interface editor.

4. The user-defined interface editing method as claimed in claim 1, wherein the interface comprises at least one display component.

5. The user-defined interface editing method as claimed in claim 4, wherein the display-related information comprises descriptions of the display components.

6. The user-defined interface editing method as claimed in claim 5, wherein the editing changes the description(s) of the display component(s).

7. The user-defined interface editing method as claimed in claim 5, wherein the description for one specific display component may be any combination of the following parameters:
position of the display component;
color of the display component;
size of the display component;
shape of the display component;
string shown in the display component; and
function corresponding to the display component.

8. The user-defined interface editing method as claimed in claim 1, wherein the modified information is parsed by a parser in the mobile electronic device before the interface display.

9. The user-defined interface editing method as claimed in claim 1, wherein the modified information is recorded as an XML file.

10. The menu user-defined interface editing method as claimed in claim 2, wherein transmission is wireless.

11. The menu user-defined interface editing method as claimed in claim 2, wherein transmission is wired.

12. A user-defined interface editing system, comprising:
an interface editor, editing display-related information of an interface as modified information; and
a mobile electronic device, coupled to the interface editor, receiving the modified information, and displaying the interface according to the modified information.

13. The user-defined interface editing system as claimed in claim 12, wherein the mobile electronic device further comprises a sending module sending the display-related information of the interface from the mobile electronic device to the interface editor.

14. The user-defined interface editing system as claimed in claim 12, wherein the interface comprises at least one display component.

15. The user-defined interface editing system as claimed in claim 14, wherein the display-related information comprises description(s) of the display component(s).

16. The user-defined interface editing system as claimed in claim 15, wherein the interface editor edits the display-related information by changing the descriptions of the display components.

17. The user-defined interface editing system as claimed in claim 15, wherein the description for one specific display component may be any combination of the following parameters:
position of the display component;
color of the display component;
size of the display component;
shape of the display component;
string shown in the display component; and
function corresponding to the display component.

18. The user-defined interface editing system as claimed in claim 12, wherein the modified information is parsed by a parser in the mobile electronic device before the interface displaying.

19. The user-defined interface editing system as claimed in claim 12, wherein the modified information is recorded as an XML file.

20. The user-defined interface editing system as claimed in claim 12, wherein the interface editor further transmitting the modified information to the mobile electronic device, and the transmission is wireless.

21. The user-defined interface editing system as claimed in claim 12, wherein the interface editor further transmitting the modified information to the mobile electronic device, and the transmission is wired.

22. A mobile electronic device, comprising:
a reception module, receiving modified information from an interface editor, wherein the modified information is produced by editing display-related information in the interface editor; and
a parser, coupled to the reception module, parsing the modified information.

23. The mobile electronic device as claimed in claim 22, further comprising a display module, coupled to the parser displaying the interface according to the modified information.

24. The mobile electronic device as claimed in claim 22, further comprising a sending module, coupled to the interface editor, sending the display-related information of the interface from the mobile electronic device to the interface editor.

25. The mobile electronic device as claimed in claim 22, wherein the interface comprises at least one display component.

26. The mobile electronic device as claimed in claim 25, wherein the display-related information comprises description(s) of the display component(s).

27. The mobile electronic device as claimed in claim 26, wherein the description for one specific display component may be any combination of the following parameters:
position of the display component;
color of the display component;
size of the display component;
shape of the display component;
string shown in the display component; and
function corresponding to the display component.

28. The mobile electronic device as claimed in claim 22, wherein the modified information is recorded as an XML file.

29. The mobile electronic device as claimed in claim 22 is a mobile phone.

30. The mobile electronic device as claimed in claim 22 is a PDA.
